(19) United States
(12) Patent Application Publication
(10) Pub. No.: US 2003/0177051 A1
(43) Pub. Date: Sep. 18, 2003

(54) Method and system for managing worker resources

(76) Inventors: Robin Driscoll, Los Altos Hills, CA (US); Kathy Lane, Los Altos Hills, CA (US)

Correspondence Address: MORRISON & FOERSTER LLP, 755 PAGE MILL RD, PALO ALTO, CA, 94304-1018, US

(21) Appl. No.: 10/148,757

(22) PCT Filed: Dec. 1, 2000
(86) PCT No.: PCT/US00/42479

(51) Int. Cl. G06F 17/60

(52) U.S. Cl. 705/9

(57) ABSTRACT

This is a worker related data management system for efficiently collecting data, moving data, and executing decisions based upon signals and inputs of various parties who have access to information stored at some central database location. Key to the system and method is a reliable infrastructure for determining that communications with the system originate from parties who have been granted access to produce such communications. Such infrastructure enables an efficient system and method for tracking information and making management decisions, such as decisions to cause payment of a supplier, without the same level of checking required by prior existing systems and methods.

### TECHNICAL FIELD

This invention relates generally to integrated systems and networks for processing worker-related information and more particularly to the creation, storage, processing, sharing, and updating of worker-related information between entities and alternative arrangement workers of various types.

### BACKGROUND ART

Entities throughout the world spend significant resources managing the information related to worker resources including security information, benefits information, timesheet information, and resume information. The documentation for alternative arrangement workers is particularly burdensome, since their status within particular entities is often in flux. Several recent technological developments have brought paperless, totally integrated employee resource management closer to reality. Some of these developments are described in published documents.

A dynamic project management system is described in U.S. Pat. No. 5,765,140 to Knudson, et al. The system includes a server network and a master database. The network is configured to identify a personnel resource pool including a plurality of users. A project planning tool is used to effect the project plan including a plurality of tasks to be performed by the users in accordance with respective time schedules. The network is configured for translating the project plan into the master database to effect a work assignments table including a list of project tasks assigned for completion by each of the users. Time sheets are periodically prepared in the master database from the work assignments table and include a list of the project tasks assigned to a respective user and a time period record for recording time entries therein. Actual time expended in performing the tasks is fed back to the project plan for managing completion of the tasks in accordance with the time schedules. In a preferred embodiment, a funding source is mapped to the project plan so that cumulative labor cost may be tracked based on actual time expended for the project tasks.

A personal ID memory card/agency method is described in U.S. Pat. No. 5,552,586 to Kalman et al. This patent describes a scheme wherein an interagency planning document for treatment of an agency client is electronically created and stored in a memory card which is provided to the client. The client retains the memory card for record purposes. Information on the memory card can be shared with other agencies using a palmtop computer and electronic mail or bulletin boards. The planning document can be updated on a continual basis in the memory card eliminating the need for the client to amass large amounts of paperwork. The palmtop computer may contain various databases which may be common to a number of agencies to reduce the vast amount of paperwork and documentation preparation time presently complicating client-agency relationships.

An electronic automated information exchange and management system is described in U.S. Pat. No. 5,832,497 to Taylor. According to this description, a computer implemented system is provided in order to manage the exchange of information through two databases. According to the preferred configuration, the system manages a database of job postings. Each posting is stored in a job record, and the system is capable of searching on a plurality of keys in the job record to identity a job record suitable to a particular applicant. The system then facilitates creation of a resume record and designation of the resume record for an accessible resume base or a selected job record. Finally, the system permits query of a resume base in order to identify recruitment candidates for job positions.

A method and apparatus for accessing a portable personal database as for a hospital environment is described in U.S. Pat. No. 5,291,399 to Chaco. A distributed data processing network is described having multiple memory card databases at terminal nodes of the network. The network is programmed to automatically perform routine communications operations such as conveying identification information between the terminal nodes and interior nodes. The network is implemented in a hospital environment and the databases include information on patients and hospital personnel. Using the automatic communications facilities of the network patient information from the database is displayed at a nurse station when the patient initiates a nurse-call or automatically when medication, also recorded on the card, is due. In addition, the system may be used to locate hospital personnel and equipment, to audit the use of controlled substances and to automatically assemble emergency response teams.

A computer system and method for storing medical histories using a carrying size card is described in U.S. Pat. No. 5,659,741 to Eberhardt. This document discloses a computer system and method for programming it for storage of individual medical histories on a storage device, preferably about the size of a credit card, for adding new medical data about the individual to the device and for communicating with other computers to retrieve large data records about the individual. The disclosure also describes enabling a second computer to collate and sort data relating to selected medical fields from the data of such individual and from the data about other individuals transferred to the second computer.

A method and system for maintaining and updating computerized medical records is described in U.S. Pat. No. 5,899,998 to McGauley et al. In this disclosure, a distributed database architecture is described for storing medical information in a self-updating system which employs point-of-service stations disposed at medical service locations. Each patient carries a portable data carrier such as a smart card that contains the patient's medical history. Interaction between the portable data carriers and the point-of-service stations effects a communication link that ties the distributed databases together without the need for online or live data connections. The point-of-service stations are also interconnected over a communications network through a switching station which likewise does not rely on online, live communication. The database system uses an object-oriented update object to distribute data which has been generated when a portable data carrier is not physically present and to automatically distribute data without the necessity of accessing a masterfile.

A low cost method employing time slots for thwarting fraud in the periodic issuance of food stamps and other benefits is described in U.S. Pat. No. 5,553,155 to Kuhns et al. According to this disclosure, upon monthly revalidation of a benefit, the client's personal identification number is read off of the client's benefit card and a computer produces a time slot assigned to the client who receives a food benefit allocation for the month only if the current date and time of day is within his assigned time slot. The assigned time slot is tied to his unchanging biometric characteristics. Transfer of a second fraudulently obtained card to an accomplice is thwarted by ink jet printing the applicant's facial image on the benefit card when issued, or using the personal identification number to display his facial image on a monitor.

In U.S. Pat. No. 4,459,304 to Eisenmann, smart card techniques for motor vehicle record administration are described for integrating and administering records related to the ownership and/or operation of motor vehicles. A smart identification card stores and administers a plurality of motor vehicle records corresponding to a single motorist. These motor vehicle records include items selected from the group of motor vehicle registration information, drivers license information, vehicle code violations, automobile insurance information, parking garage entry times, parking garage account balance, highway toll account balance, motor club information, and environmental inspection information. Each smart identification card is equipped to interact with various computer databases through the utilization of a conventional communications link in conjunction with a smart card scanner, each of the computer databases administering motor vehicle records.

A device, system, and methods of conducting paperless transactions are described in U.S. Pat. No. 5,884,271 to Pitroda. More particularly, a universal electronic transaction (UET) card is described which is capable of serving as a number of different credit cards, bank cards, identification cards, employee cards, medical and health care management cards and the like. The UET card includes storage elements, an input interface, a processor, a display, and a communications interface. In a preferred embodiment, the UET card stores transactional information to eliminate paper receipts and includes security features to prevent unauthorized use. The UET card may also be used to replace conventional currency and traveler's checks, and may be configured to store and display promotional information, such as advertising and incentives. Also described are systems for using UET cards, for example, health care management systems, communication interface units, and methods for using the same, including methods of issuing an account authorization to a UET card, a method of transferring transactional and account information between a UET card and a personal computer or a mainframe computer, a method of using the UET card as a remote terminal for a mainframe computer, and a method of conducting an electronic transaction.

A system and method for accounting for personnel at a site and system and method for providing personnel with information about an emergency site are described in U.S. Pat. No. 5,793,882 to Piatek et al. The personnel accountability system includes an information receiving device, a processor, and a display. The information receiving device is provided for receiving information from a data storage device carried by the personnel or from the personnel directly. The received information pertains to the personnel, and may include identification, qualification, and/or medical information. Upon receiving the data, the system subsequently stores and displays the received information. The system may also be used to receive information regarding a site.

A smart card access control system is described in U.S. Pat. No. 5,204,663 to Lee. The described system comprises an integrated-circuit card key having contact pads and a sufficient memory capacity to store key access information and transaction information, information in the integrated circuit integral therein at respective addresses, and an acceptor which includes a memory to store lock access information. Also described is circuitry for reading the key and lock access information whenever the contact pads of the key are electrically engaged with the acceptor.

There is a need for a worker resource management system which has the capability to share all relevant variables related to a particular worker while enabling management within various organizations to efficiently use such information to manage worker-related resources in the firm such as the workers themselves, information in the form of databases and data structures, and access to more tangible assets such as buildings and machines. There is also a need for a system which enables alternative arrangement workers to maintain a portable computer-based identity independent of their particular employment status at a given time. This invention, which preferably incorporates secure electronic communication techniques enabled in part by hardware tokens such as smart cards, efficiently addresses this need.

### SUMMARY OF THE INVENTION

This is a worker-related data management system for efficiently collecting data, moving data, and executing decisions based upon signals and inputs of various parties who have access to information stored at some central database location. Key to the system and method is a reliable infrastructure for determining that communications with the system originate from parties who have been granted access to produce such communications. Such infrastructure enables an efficient system and method for tracking information and making management decisions, such as decisions to cause payment of a supplier, without the same level of checking required by prior existing systems and methods.

In one variation, an inventive system comprises a central information system having a central database and a local information system, such as a personal computer or portable computing device. The system is configured so a worker may logon to the central information system via the local information system, input work-related data to the central database, and forward the work-related data to the consumer for approval. The consumer may logon to the central information system via a local information system, examine and approve the work-related data, and cause payment of a supplier before receipt of an invoice from the supplier.

In another variation, the invention comprises a method for managing worker resource information and placing invoice generation under the control of a consumer, the method comprising providing a logic-backed interface through which the worker may logon to the central database, input work-related data to the central database, and forward the work-related data to said consumer for approval, and providing an interface through which the consumer may logon to the central database, examine and approve the work-related data, and cause payment of the supplier before receipt of an invoice from the supplier.

### BRIEF DESCRIPTION OF THE DRAWINGS

FIG. 1 is a flowchart depicting a prior art timesheet and payroll process for alternative arrangement workers.

FIG. 2A is a flowchart depicting an overview of one variation of the preferred secure communication procedure for exchanging electronic information.

FIG. 2B is a flowchart depicting an overview of another variation of the preferred secure communication procedure for exchanging electronic information.

FIG. 3 is a flowchart depicting an overview of one variation of the inventive resource management system.

FIG. 4 is a flowchart depicting an overview of one variation of the registration process associated with the inventive system.

FIG. 5 is a flowchart depicting an overview of one variation of the work request entry process associated with the inventive system.

FIG. 6 is a flowchart depicting an overview of one variation of the assignment process associated with the inventive system.

FIG. 7 is a flowchart depicting an overview of one variation of the access and usage process associated with the inventive system.

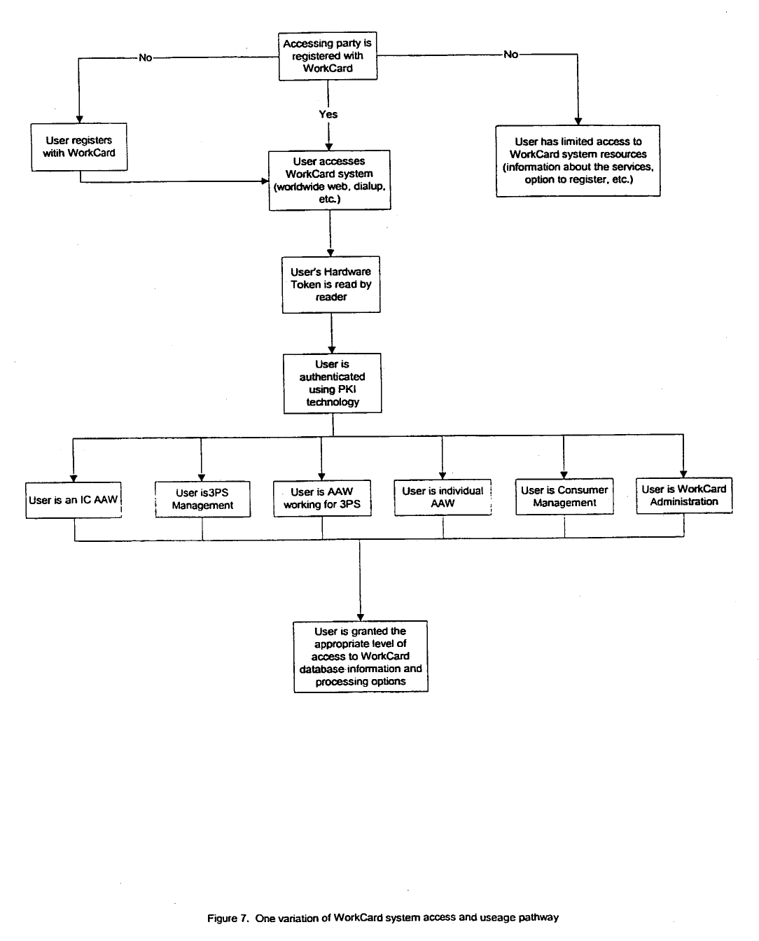

FIG. 8 is a flowchart depicting an overview of one variation of the inventive resource management system.

### DETAILED DESCRIPTION

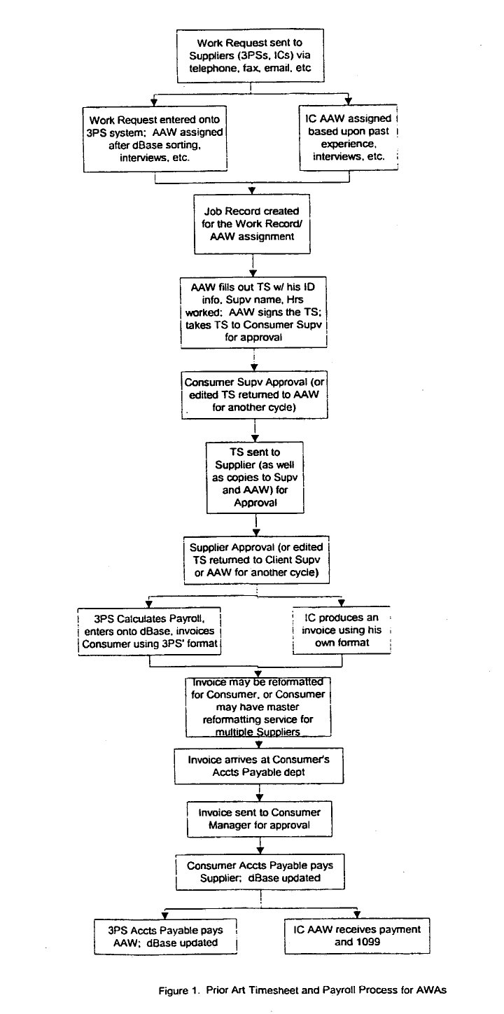

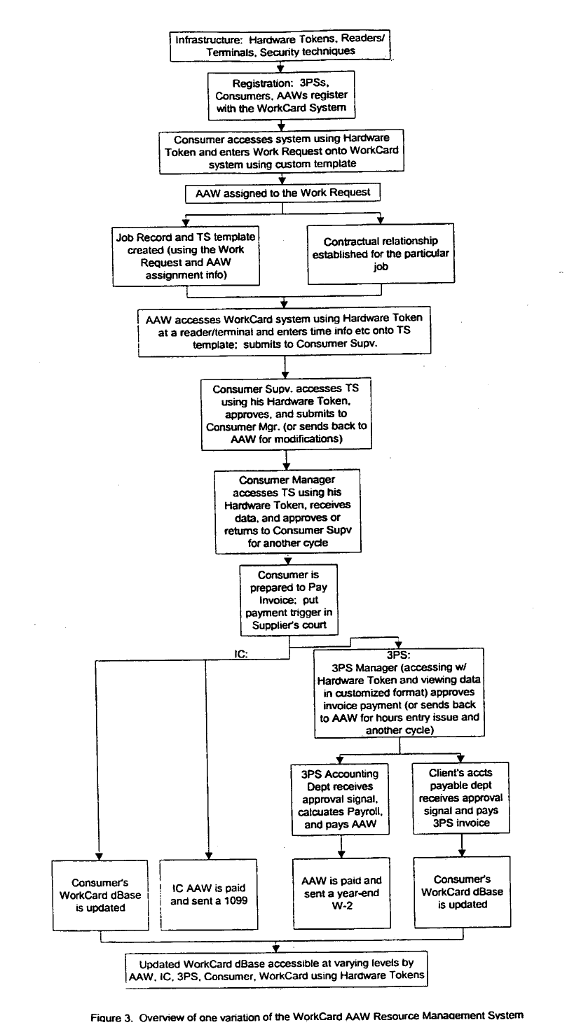

This is a system and method for enabling efficient management of alternative arrangement worker (hereinafter “AAW”) resources via secure electronic communications. The system incorporates modern information technology and devices to enable a secure information sharing process which eliminates the need for much of the paper trading involved in present worker resource management systems. FIGS. 1 and 3 are illustrative for comparing prior AAW resource management systems with the inventive system and method described herein.

Referring to FIG. 1, a flowchart depicting a prior art timesheet and payroll process for alternative arrangement workers is shown. In the first step, a work request document is produced, generally by the consumer of AAW resources (i.e. the company needing the particular work done; hereinafter “consumer”) . For example, a company may produce a work request document outlining their need for a programmer having two years experience to work for three months starting in December, 1999 at a rate of $20 per hour. Perhaps after unsuccessfully trying to hire or transfer an existing company employee, company management might choose to pursue an AAW relationship in the form of an independent contractor or a temporary hire from one of the temporary employee services (the company would intend to become the “consumer” of AAW resources supplied by an AAW supplier)—Potential AAW suppliers come in many forms including temporary employee firms such as Kelley Temporary Services (known as a “third party supplier” or “3PS”), independent contractors (or “IC”s) who essentially may be in the position of supplying themselves. The work request or details thereof would be transmitted to the AAW supplier by fax, mail, electronic mail, telephone, or other known systems. As shown in the figure, third party suppliers receiving the work request information likely would enter the details of the work request onto their work request information management system This would probably require some computerized database information entry. Attempts would then be made by supplier and consumer to assign a proper AAW to the work request. This would most likely involve some interviewing, some database processing and analysis, and perhaps some automated matching in accord with currently available systems such as those described in U.S. Pat. No. 5,832,497 to Taylor.

After an AAW was assigned to the work request, a job record would be created for the particular work assignment having information regarding the particular work request and assigned AAW. Depending upon the particular consumer, the AAW's history with the third party supplier and consumer, security and training requirements of the third party supplier and consumer, and other factors, some type of clearance effort would occur for the AAW. Next the AAW would show up for work and start to bill hours to the work request by entering his work hours onto a timesheet, the timesheet being a traditional paper document or perhaps a more updated computer-generated document created using locally installed or internet-based software. At the end of the week, this document would be signed and submitted to the consumer supervisor of the AAW for approval. If the consumer supervisor approved, the signed document would be forwarded to the third party supplier with copies going to the AAW and the approving consumer supervisor. If the consumer supervisor did not approve the timesheet, the timesheet would be cycled back to the AAW, perhaps with comments.

After approval by a manager or supervisor of the particular work request on the third party supplier (or independent contractor) side, the document would be forwarded to the payroll department of the third party supplier for payroll calculation and entry of such information onto some type of database. As shown in the figure, the third party supplier would then send an invoice to the consumer using an invoice format which is most likely customized for the particular third party supplier. Should the consumer be using multiple third party suppliers, as many do, the consumer's accounting department would have to convert the information from these invoice types to their standard database formats for analysis—or would have to hire what is known in the industry as a “master invoice supplier” to receive the various invoice types and enter them onto a preferred standardized database for delivery to the consumer.

Upon receipt of the invoice from the third party supplier, the consumer's accounts payable department likely would send the invoice to a manager in the company for approval, despite the fact that a supervisor of the company already approved the timesheet. After the final round of approval on the consumer side, the invoice would be sent to the consumer's accounts payable department which would pay the invoice and update its database regarding the transaction. The AAW supplier's accounts payable department would pay the AAW (in the case of an independent contractor AAW, the paid invoice would go directly to the independent contractor, as would an Internal Revenue Service form 1099 document) in accord with schedules dictated by applicable labor laws. Generally, the AAW would be paid subsequent to the consumer's approval of the timesheet but before payment of the supplier's invoice by the consumer's accounts payable department. Workers are typically paid weekly, while supplier invoices are typically paid monthly. Due to the traditional style document checking and approval steps required by such processes, the supplier would not be paid by the consumer before the consumer receives an invoice for the work. Indeed, consumers are in a reactionary position with such processes; they wait to receive invoices from suppliers, check and approve such documents, and pay the suppliers. The result of such reactionary positioning is that consumers find themselves in a document-checking role wherein they must check and approve invoice documents from various suppliers in various formats.

While some of the steps within existing processes such as this have been made more efficient due to information systems improvements (computerized databases for matching AAWs with work requests, computerized or web-based timesheet methods, electronic mail, facsimile, etc.), the process remains cumbersome due to lack of integration of the subsystems involved in worker resource management and focus on improving the subsystems rather than the overall process.

The inventive system and method takes advantage of electronic communication protocols which are both reliable and secure to enable trusted electronic communication and eliminate much of the manual checking necessitated by existing systems. For the purposes of this description, the term “electronic communication” refers to wired and wireless communication techniques known in the art of information systems both small and large which use various protocols and hardware setups. Wireless electronic communication systems, such as those enabled by infrared, cell phone network, or satellite network technology, are particularly desirable because they enable relatively easy expansion and mobility of certain components such as portable information systems which may be electronically linked to the Workcard system. In the preferred variation, the inventive system and method operate using an Application Service Provider (or “ASP”) configuration such as those which are well known in the art of internet software. Broadly defined, an Application Service Provider is an organization or third-party which provides software applications over the Internet, typically for a subscriber or peruse fee. An ASP generally hosts and manages a software application from a centralized location using a server or database, and coordinates the ongoing support, maintenance and upgrading of the application therefrom. Users of ASP software generally access and operate the software using locally installed internet browsing software such as Microsoft Internet Explorer running on local information systems such as personal computers, personal data assistants (known as “PDAs”), cell phones, or other known local information systems.

An important aspect of the inventive system and method is the establishment of authenticated secure communications between parties involved in the alternative arrangement worker resource management process. It is important that different persons within each of the involved organizations may be granted different access privileges in accord with the system design, and that a communication from one party may be authenticated as a communication which indeed originated from said party. The trust which evolves from such authentication enables the system to handle transactions very quickly with less manual checking—thus a significant portion of the efficiency gain.

Several variations of secure communication are known in the art. They vary from relatively simple systems, often based upon transmission of a username and password, to relatively complex systems which involve portable memory and processing devices and the reading and processing of biometric data such as fingerprints or iris scan images. Some of the relatively simple security techniques, such as those based on transmitted username and password, may be violated by sophisticated computer users due to the fact that phrases of characters are often transmitted over relatively unsecure communication devices in unencrypted form. Such phrases may be entered using a keyboard, magnetic strip reader and encoded magnetic strip, geometric pattern detector and encoded geometric pattern, optical pattern reader and encoded optical pattern, or other known magnetic, optical, or geometric media reader and encoded media.

Some encodable media devices are known as hardware tokens. The term “hardware token” is generally associated with devices having a small memory device which is highly portable, such as a silicon chip or magnetic strip. Hardware tokens may be classified as either active or passive. Passive hardware tokens, such as plastic cards with data-holding magnetic strips, small devices using customized optical or geometric patterns, or chips having memory capacity for passwords or the like, have an advantage over simple memorize and key-in techniques in that the stored codes may be quite complex and lengthy, since they are stored on the media of the hardware token and need not be memorized or typed in on a keypad.

Active hardware tokens, in addition to having memory capacities of various sizes, also have microprocessors. Active hardware tokens are highly preferred in the inventive system and method due to their ability to process information locally without transmitting it from memory onto another perhaps more unsecure system. For example, an active hardware token having memory capacity for stored fingerprint data and the processing capacity to compare the stored fingerprint data with incoming sampled fingerprint data from another device such as a fingerprint reader can make the comparison of the two prints without transmitting the stored fingerprint data to another device. Less transmission to unsecure devices generally equates to better overall security. Security options which involve active hardware tokens, such as those which are described below, are hereinafter referred to as enabling “secure logon”, “secure access”, and “secure communication” procedures, while security options utilizing passive hardware tokens, memorized keyed-in passwords, and the like, are hereinafter referred to as enabling “semisecure logon”, “semisecure access”, and “semisecure communication” procedures.

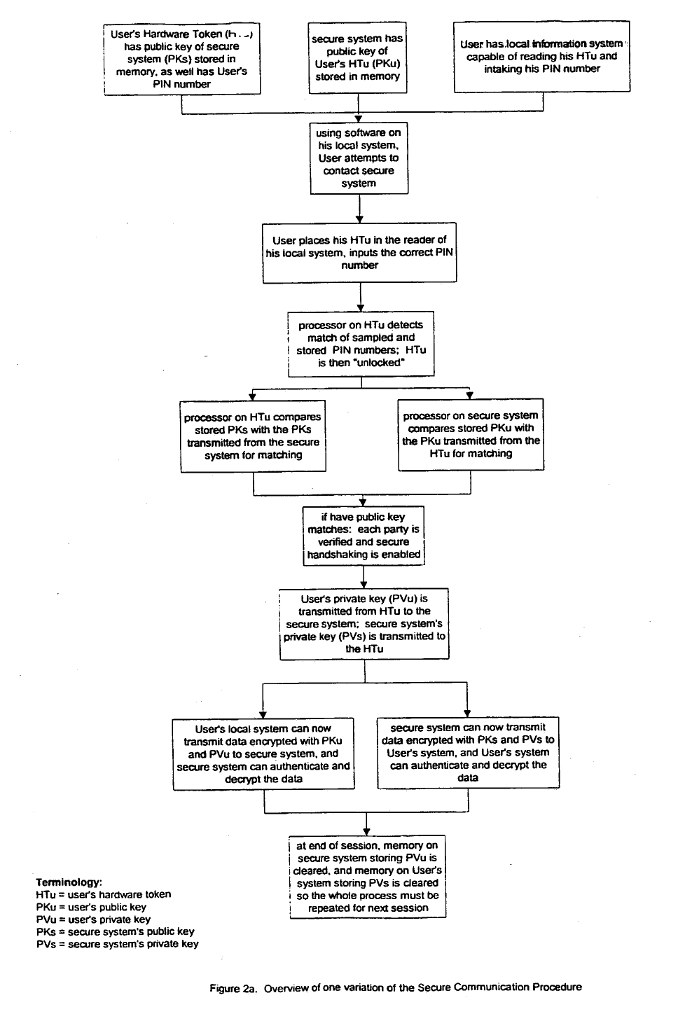

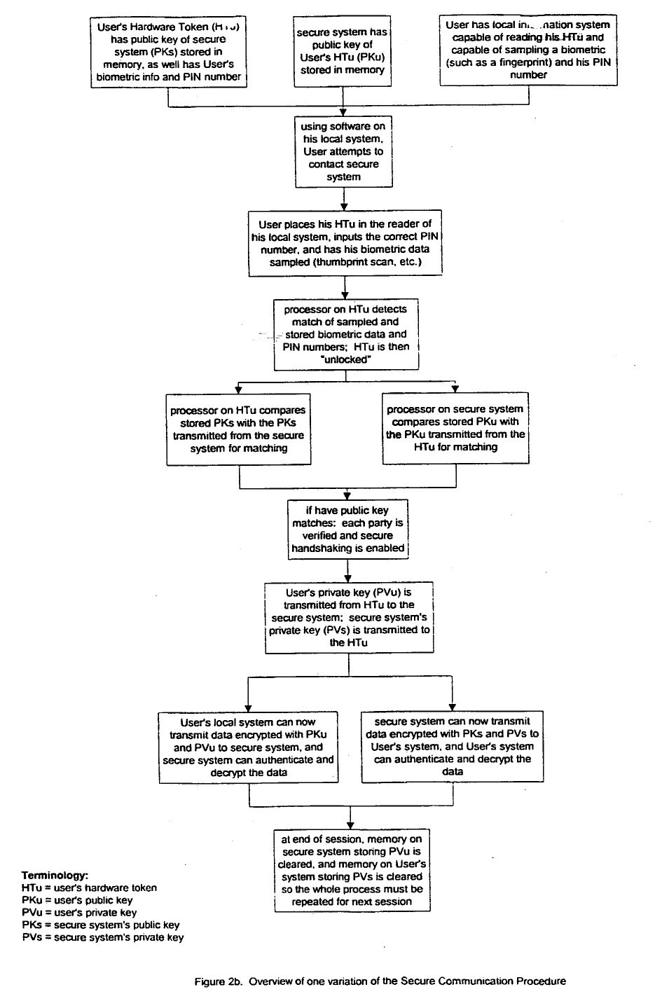

Two variations of a secure communication protocol are particularly preferred. They are depicted in FIGS. 2a and 2b. Each of these variations uses public and private keys which preferably are encryption algorithms in the form of phrases of characters which are stored in memory on some device. The private keys are generally shared by the communicating parties upon initialization of their relationship. In one variation of the process, after a user registers to have secure access to a system, he receives a hardware token having not only his public and private keys, in combination his “digital certificate”, stored thereon, but also the public key for the secure system. Similarly, upon registration of said user, the secure system receives a copy of the user's public key for storage and later comparison.

Referring to FIG. 2a, the user's hardware token has the user's digital certificate stored in memory with the user's personal identification number (PIN) or password, as well as the public key to the secure system. Likewise, the secure system has its digital certificate stored in memory along with the user's public key. When the user desires to access the secure system, he places his hardware token in a reader (or “hardware token connectivity device”) connected with his local information system (a personal computer, PDA, or other similar information processing system) and uses the software on his local system to contact the secure system (possibly a central information system such as a server, which has a central database) through an interface, generally a graphical user interface such as an HTML page or others known in the art, which enables the connectivity between an input device such as a keyboard on the local information system and the secure system. At some point in the depicted variation, the user must input his password of PIN number to “unlock” his hardware token so the information systems involved may conduct analysis of the data stored thereon. Comparisons then take place at each end of the attempted communication: the secure system detects whether the public key of the user matches that which is stored on the secure system; likewise, the user's system (preferably the processing occurs on the hardware token itself) compares the public key of the secure system with that which is stored locally on the hardware token. If the public keys match on each side, secure handshaking is enabled and a swapping of entire digital certificates occurs. After this transaction of data, the user can send information encrypted using his digital certificate information to the secure system, and the secure system can decrypt the information using the user's digital certificate at the other end. Likewise, the secure system can send information encrypted using the secure system digital certificate to the user, and the user's information system can decrypt the information using the digital certificate of the secure system at the other end. After the secure session is complete, each of the respective communicating parties loses memory of the other party's private key (although the public keys of each other are kept in memory, as described above after registration or initialization) to ensure that the process must be repeated for each desired secure communication session.

Referring to FIG. 2b, another preferred variation of the secure communication procedure is depicted, this variation having the added security provided by the use of biometric information. The main difference between this variation and the one described above and in FIG. 2a is that the user's hardware token has storage capacity for biometric information, and has the user's biometric information (fingerprint, iris scan result, voice scan result, or other known biometric indicator) stored on the hardware token itself along with the user's PIN and digital certificate information. The processor on the hardware token in this variation has the ability to compare the stored biometric information with similar biometric information recently sampled from a biometric sampling device attached to the user's local information system, such as a thumbprint, voice, or iris scanner. U.S. Pat. Nos. 4,991,205, 4,993,068, and 4,995,081, for example, teach various schemes for recording biometrics onto small devices and using said devices to confirm the identity of a person carrying them.

With the depicted variation, the user is not able to “unlock” his hardware token and proceed with developing a secure session with a remote secure information system unless he knows his PIN number and also is successfully sampled (thumbprint scanned, etc.) and found to be a match with the person intended to have access to the hardware token and secure system.

U.S. Pat. Nos. 5,963,980, 5,510,074, 5,901,303, 5,875,480, 5,802,325, 5,690,773, 5,682,031, 5,625,791, 5,943,624, 5,943,423, for example, teach various suitable hardware tokens. U.S. Pat. Nos. 5,969,333, 5,969,330, 5,955,722, 5,936,222, for example, teach various reading devices for hardware tokens. U.S. Pat. Nos. 5,592,554, 5,604,805, 5,724,425, 5,475,758, 5,915,024, 5,006,698, 5,946,397, 5,910,989, 5,825,882, 5,754,675, for example, teach various suitable secure and semisecure communication methods and systems. International corporations such as Gemplus, Schlumberger, Siemens, and Philips, and Fujitsu have many available hardware token, reader, and encryption method products available which are suitably used in the inventive process and system.

Referring now to FIG. 3, a flowchart depicting one variation of the inventive worker resource management system and process (the “WorkCard system” and “WorkCard process”) is shown in overview form. A key aspect of the system is billing document control from the consumer side, rather than from the third party supplier side as in existing models. As shown in the figure, certain infrastructure, such as the secure communication infrastructure described above, is preferred to increase information system security and efficiency. Another key aspect of the system is its multiuser aspect which preferably enables many users from many organizations to interact with the system simultaneously, each user having particularized secure access based on the access privileges granted to him by his supervisors and WorkCard system administration.

Systems comprising smart card hardware tokens and smart card readers are preferred because smart cards are reliable, relatively inexpensive, and have significant memory and processing capabilities for secure and semisecure access protocols. Their capabilities help to meet many of the infrastructure demands of the preferred system, particularly in regard to secure access. An additional benefit of using the smart card hardware token platform is that smart card readers are becoming increasingly common subcomponents of widely available systems such as personal computers, supermarket transaction devices, and automated banking systems. In order to take advantage of the infrastructure necessary for secure communications in the depicted variation, a registration process must occur to establish users of the system and setup access and other privileges for such users.

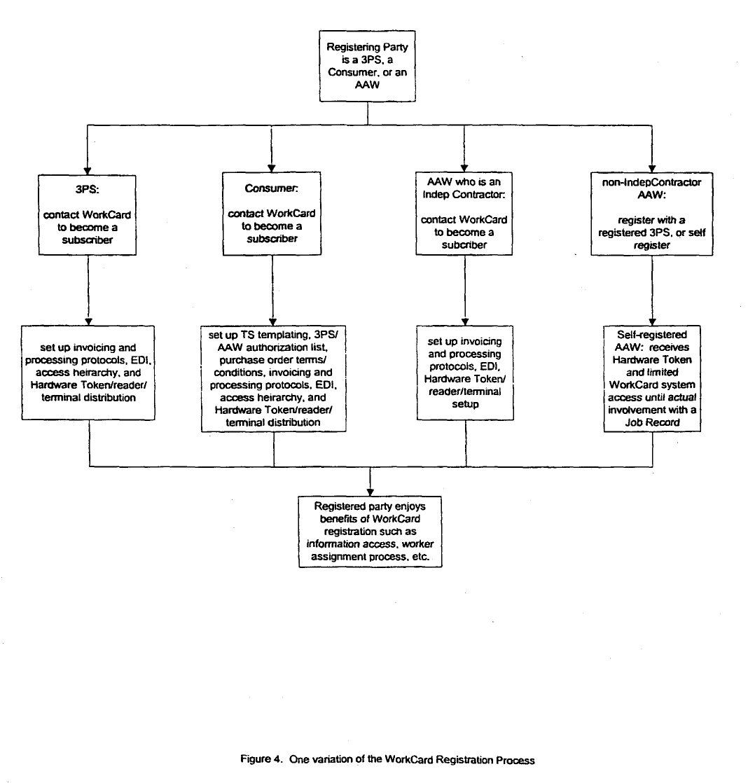

The registration process may occur at various points in the overall process. Registration, important for maintaining the security of the system, comprises gaining certain information from each party and granting certain access privileges in accord with the rules prescribed by involved management. FIG. 4 depicts further details of a variation of the registration process Registering with WorkCard as a registered user will give the third party supplier many added benefits, such as customized invoicing and data processing protocols, information system handshaking using electronic data interchange (EDI) techniques known in the art for automatically converting documents and the information thereon from one format to another, access hierarchy or restricted access for various operators within the user's organization, preferred lists of AAWs or consumers, and hardware token technology for secure access control to the user's information on the WorkCard system. The registration interaction between supplier management and WorkCard may take place via electronic mail, video conference, telephone, or other known communication techniques. Recall that the system comprises an application service provider configuration in the preferred variation.

As shown in FIG. 4, consumers, independent contractors, and individual alternative arrangement workers may register with WorkCard for similar benefits in a similar manner. In the preferred variation, users, whether they are workers, supplier representatives, consumer representatives, or even WorkCard administrators, must register before they can submit a work request to the WorkCard system, get involved with a particular transaction, or enjoy other benefits afforded a registered user of the system such as secure access to timesheets, invoicing, automatically updated resumes and security clearances, electronic data interchange, customized timesheets and work requests, and management reporting. Customization preferably is accomplished using HTML programming for the web-accessible interface in the prefered variation.

Registration inquiries will be dictated by the involved parties and by the labor laws. If a chief personnel office of a corporation, for example, wishes to register his corporation as a registered WorkCard consumer organization, he may have the freedom to form binding agreements with WorkCard administration regarding billing, confidentiality, and other procedures which may affect each transaction involving his organization. He may also choose to develop custom formatting for data input interfaces and may make decisions regarding logic which may run in the background behind work-related data interfaces used by workers to enter their timesheet, expense, and other information.

Independent contractor AAWs may have similar freedom to structure their relationship with the WorkCard system during registration due to the fact that they are essentially their own supplier and their own entity.

Registration decisions available to AAWs employed by third party suppliers may be more limited, depending upon what the pertinent third party supplier decides to let them decide during its own registration process. To summarize, registration is a process wherein parties are authenticated the “old fashioned way” using paper documents, photo identifications, and the like, and are granted appropriate privileges for using the inventive system as prescribed by rule makers within the pertinent organizations.

It is important to note that modifications to protocols established or approved during a first registration attempt may be made later by users having the appropriate authority and access privileges to change registration variables.

Having the infrastructure and preferably the registration aspects of the system in place enables users to access the system and originate particular worker resource transactions.

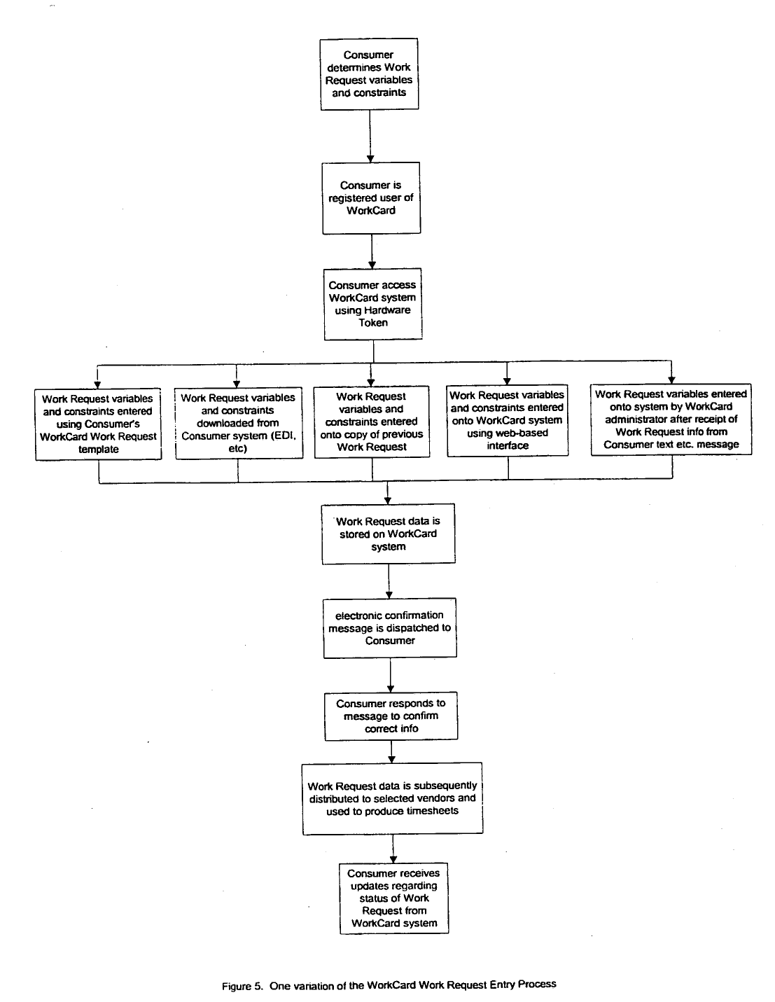

Generally a worker resource transaction originates with the filing of a work request by a consumer as shown in FIG. 3. FIG. 5 depicts further details of the work request process. If the consumer has determined the work request variables such as hourly pay rate, maximum hours for the task, resume prerequisites, and preferred third party suppliers or AAWs, he may access the WorkCard system via secure or semisecure logon and enter such information in a variety of ways, as shown in the figure. The work request information may be entered, for example, using the registered consumer's customized work request template from the preferred web-based system interface. More specifically, a person within the consumer organization having access to the work request submission subprocess, presumably some type of manager, may logon and access the work request entry interface on the web-based system interface, enter the proper information, check over the completed work request, perhaps receive responses from logic which may be built into his customized work request interface such as maximum hours per week, such logic being designed into the particular user's work request entry interface at registration and functioning to detect unacceptable entries using scripts or other techniques known to programmers, and electronically submit the work request to the WorkCard system.

Alternatively, the consumer may access the WorkCard system and have a previously prepared work request downloaded from his information system onto the WorkCard system using electronic data interchange (EDI) technology, and then receiving the benefit of any logic built into the work request entry procedure. As shown in the figure, the user may also enter the work request onto the WorkCard system using a standard work request template available to all registered users, or may include a textual description or voice dictation clip in an email and request that WorkCard administration personnel place the information into a work request template and transmit it back to him for checking and subsequent submittal onto the WorkCard system.

Regardless of the particular submittal variation, a receipt of the work request submittal preferrably is transmitted to the consumer in the form of an electronic confirmation message having the details of the work request outlined as submitted or in some other desired form which, for example, highlights certain key factors of the work request such as maximum budget. Upon registration, the user preferably has the option to select the receipt and update format and media (electronic mail message, web posting, pager or cell phone code, voice mail, desktop fax, frequency for sending updates, etc.). After the submitting party responds to the electronic confirmation message indicating in the affirmative that the facts therein are correct, the work request is submitted to the active work request database on the WorkCard system where it is distributed to vendors and/or AAWs preferred by the submitter. The facts within the particular work request, as well as certain registration information from the submitter such as maximum allowed work hours per week, interviews required before assignment, preferred suppliers, etc. subsequently are used to create electronic documents designed to allow an assigned AAW to enter work-related data pertinent to the particular assignment, such as timenotes and related expenses.

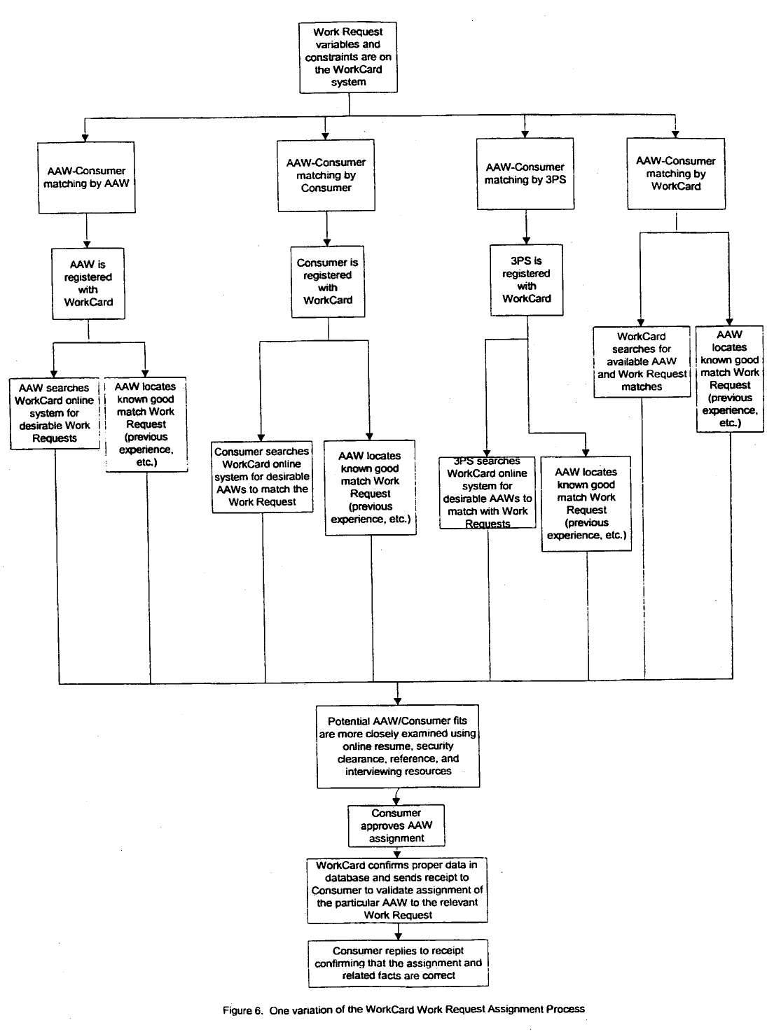

Referring again to FIG. 3, after a work request has been entered onto the active work request database on the WorkCard system, an alternative arrangement worker may be assigned to the work request. FIG. 6 depicts a variation of this subprocess in further detail. Although the paths through the depicted subprocess variation differ depending upon the relationships involved between the worker, the consumer, and any other relevant parties, the assignment process ultimately boils down to a process of making sure the best fit possible between worker and consumer is achieved. This “fit” is generally analyzed using known systems such as interviewing and computer matching of skills, availability, and other factors. Many computer-based systems focused on solving this “fit” problem are known in the employment industry, such as those described in U.S. Pat. Nos. 5,913,201, 5,911,134, 5,893,906, and 5,748,907.

If a registered alternative arrangement worker initiates the assignment process, perhaps by logging onto the WorkCard system as a registered user to find open work requests, he will have access to the work request database and may initiate further analysis by the hiring consumer by posting a notice of interest in the work request, thus initiating a message to the appropriate consumer. To find work requests of interest on the system, the registered alternative arrangement worker may, for example, search the database using job criteria, employing consumers he knows or has worked with in the past, or a particular work request he knows about. In one variation not depicted, non-registered alternative arrangement workers also have full access to the WorkCard work request database; the depicted variation requires that the AAW be registered to enter the database searching portion of the WorkCard system.

As shown in the variation depicted in FIG. 6, registered consumers and third party suppliers representing alternative arrangement workers may search the system and initiate further analysis of AAW/consumer matches in a similar fashion. The WorkCard system may also initiate this matching by using work request and AAW resume characteristics available on the database to form potentially viable matches. After further analysis as required by the particular consumer and worker, the consumer may approve the assignment, preferably using some electronic means such as email response. The WorkCard system then confirms that requisite data regarding the AAW, the work request, and the match has been entered into the database. After this confirmation, a receipt is sent, preferably electronically, to the consumer to validate the assignment. In the depicted variation, the consumer may reply to the work assignment receipt to confirm the facts therein.

Referring to FIG. 3, the assignment of a particular alternative arrangement worker to a work request results in a computer-generated timesheet of custom format, in accord with the consumer's registration requests and the facts in the submitted work request, which has time, expense, and other data entry fields.

Preferably, the WorkCard system is also configured to run logic in the background to monitor information entered onto the electronic timesheet and signal the entering party and/or other viewers that one variable has differed from the range allowed by the facts of the work request (a “logic-backed interface”). Scripts and other similar software techniques for deciding whether an entered value is acceptable based upon established rules are well known in the art of programming. The signal to the user preferably is in the form of a small flag which is linked to a message dialogue box explaining the reason for the flag.

In the preferred variation, the creation of a timesheet interface for a particular work request and worker assignment is automated by the system using accessible information stored on the system regarding the preferences of the pertinent consumer, worker, and supplier, each of which preferably has been previously established during registration procedures. For illustration purposes, consider the example below.

The depicted variation also comprises a contract formation step after the assignment of work request and alternative arrangement worker. During this step, a contractual relationship is formed wherein the parties agree to the use of the automated process, and specifically to particular invoicing and payroll terms. In the depicted variation, for example, efficiencies are gained by a contractual relationship between an independent contractor AAW and a consumer when the independent contractor agrees that his invoice will be paid as soon as the consumer approves it, without another cycle back for the independent contractor's approval. Such agreements reasonably can be made due to the reliability of the system as a whole, and particularly due to the user authentication procedures which ensure that system access privileges are only used by those parties to which they are particularly granted.

The next step in the depicted variation of the process overview is the point at which the particular job starts and the particular alternative arrangement worker uses a hardware token at the worksite for many functions, including for example secure or semisecure access to an appropriate timesheet and expense interface, secure or semisecure access to his current job hours summary for the year, secure or semisecure access to his automatically updated resume, building security access, computer terminal access, machine operation access, electronic purse features such as automated bank teller currency access, etc. The figure focuses on the timesheeting feature of the system. After timesheet, expense, and/or other work-related data has been entered by the AAW onto the system using the appropriate interface and other information has been automatically entered by components of the system (resume update codes, for example, to modify the particular resume to indicate, for example, “40 more hours worked in ISO 9001 microprocessor fabrication facility doing chemical ething; operating an Applied Materials model-x etching and polishing machine for 28.5 hours”; etc.), the data file is signed or endorsed, preferably using an electronic signature technique such as that disclosed in, for example, U.S. Pat. Nos. 5,948,103 and 5,915,024, and is electronically forwarded to the consumer supervisor.

As shown in the figure, the consumer supervisor, having securely or semisecurely accessed the WorkCard system, receives the worker-endorsed data file, preferably as an attachment to an electronic mail message, and inspects it. If the consumer supervisor approves of the data in the file, he marks the document accordingly, preferably by attaching his electronic endorsement, and forwards it, in the depicted variation, to the consumer manager who has authority to approve payment of the fees associated with the document. The consumer manager, having securely or semisecurely accessed the WorkCard system, examines the worker-endorsed and supervisor-approved data, preferably as an attachment to an electronic mail message, and inspects it.

If the consumer manager approves of the data, he marks the document accordingly, preferably by attaching his electronic endorsement, and forwards it, in the depicted variation, to one of two destinations depending upon the entities involved in the transaction and the agreements therebetween.

If an independent contractor is involved and has, for example, agreed to be bound by the terms of his endorsed timesheet data file, approval by the consumer manager leads directly to payment of the independent contractor's invoice, notation thereof in the WorkCard database, and a subsequent IRS form 1099 filing.

If a third party supplier is involved and has, for example, agreed that approval by an authorized manager of the third party supplier organization is required before the consumer pays the invoiced amount, then a third party supplier manager will securely or semisecurely access the WorkCard system and examine the consumer-endorsed data preferably sent to him as an attachment to an electronic mail message. If he approves of the information, he will mark the document in a manner similar to that used by the consumer side approving parties and forward the approved invoice to the accounting department of the third party supplier for subsequent payment of their AAW employee; in addition, the approved invoice is forwarded to the consumer's accounts payable department for payment of the invoice and database updating. A key result of this process is that the consumer has control over the work-related data necessary for invoicing and payment of the supplier so that the consumer may cause payment, electronically or otherwise, of the supplier based upon securely or semisecurely entered work-related information before receipt of any invoice from the supplier related to the pertinent work done by the worker (referred to as “non-invoiced payment” of a supplier).

Another key advantage of consumer-side control of the work-related data is management report generation. The consumer, via secure or semisecure logon procedures, has access to information on the central database pertinent to his organization and the workers and suppliers associated with his assigned work requests. The inventive system is configured to allow registered consumers to query the central database using interfaces designed during the registration process to produce reporting documents available in customized formats designed during registration. Being able to produce up-to-date reports for work requests to which many different suppliers are supplying workers is highly desirable. For illustration purposes, consider the example below.

Somewhat akin to management report generation from stored data is the maintenance, updating, and reporting of resume information to relevant parties selected by a particular worker, such as Monster.com or other parties from which a worker might gain further employment or benefit. In the preferred variation, a worker may, as part of the registration procedure, select which information would like reported to his personal resume file on the central database (all information, only time on the job information, etc.; preferably, the system is configured to disallow selective filtration of automatically retrieved data, such as noninclusion of poor remarks and inclusion of favorable remarks, to encourage reliance upon the updated resume information), the format for a resume resulting from a query to the database therefor, and destination parties to which the worker would like updated resumes sent at a given frequency (such as one new resume transmitted to Monster.com every two months). In the preferred variation, the data queried to produce a resume is updated each time work-related data is approved by consumer management.

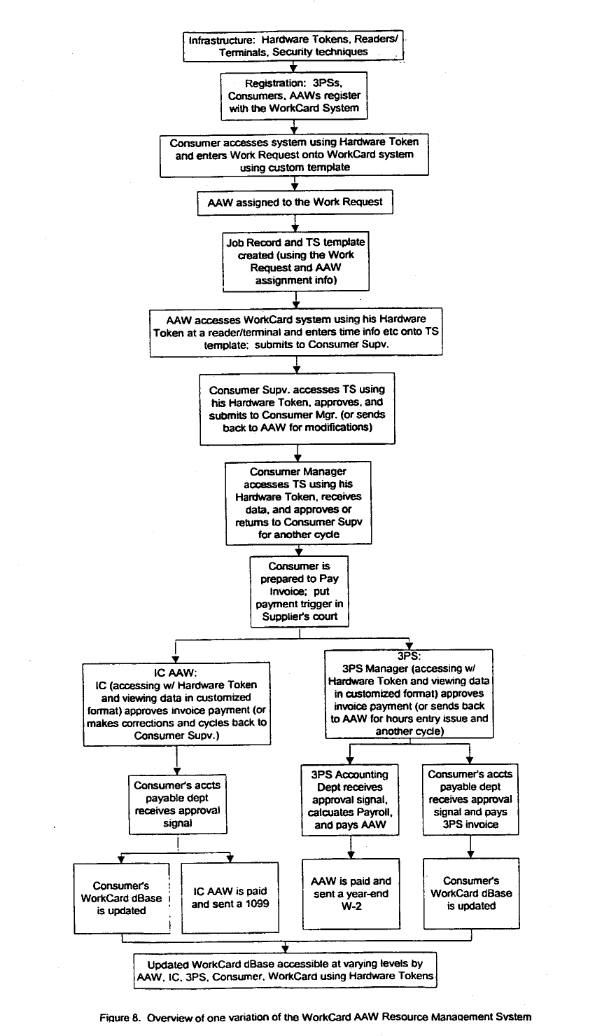

Referring to FIG. 8, another variation of the overall process is depicted. This variation differs from that depicted in the variation of FIG. 3 in that a contractual relationship between the parties is not established after the assignment phase. As shown, this may result in at least one less efficiency gain: an independent contractor does not contractually agree in advance to be paid after the consumer approves payment of a particular billing document, so the independent contractor in this variation must approve the billing document and route it back to the consumer before payment.

### EXAMPLE

For illustration purposes, a purely fictitious example is helpful. Applied Materials (hereinafter “Applied”) needs some cleanroom techs and has been unable to hire them through the usual full-time employee hiring process. Applied decides to pursue some alternative arrangement workers for a period of two months to get through a particular project in the clean room. Applied searches web-based resources such as Monster.com and finds out about The WorkCard Company. After some discussion with its usual supplier of AAWs (Kelley Temp. Services), Applied decides to use the WorkCard system and registers with WorkCard. During the registration information exchange process, Applied indicates that it doesn't want any of its AAWs to be allowed into areas marked “highly sensitive” by corporate management and that it doesn't want any of its AAWs to work overtime hours. It also selects a list of preferred AAW suppliers (including a few known good independent contractors). Applied also selects formats and content for various interfaces and transmissions, and selects a smartcard-based secure access protocol for anyone having access to its data.

Applied then securely logs on and submits a work request to the WorkCard system requesting two AAWs with minimums of 80 hours of clean room experience each, for two months. Applied indicates in the work request that it would like to interview the candidates and what times are available for interviewing. The work request is bifurcated by the WorkCard system into two work requests because two AAWs are needed at the same time. Alternatively, the system may be configured to retain a single work request requiring two AAWs for simplified processing and reporting. After the facts of the work requests are confirmed by secure electronic communications between the WorkCard system and Applied, the work requests are placed into the active work request database on a central server.

Fred, an independent contractor with cleanroom experience at Applied in the past, is registered with WorkCard as an AAW and his status on the WorkCard system is “looking for work” during the next three months. Fred receives an email message from the WorkCard system indicating that the skills on his electronically stored WorkCard resume match the requirements for an active work request from Applied, which has selected him as a preferred supplier.

Kelley Temp Services, another preferred Applied supplier and registered WorkCard user, receives an email message with current work requests. A Kelley manager sees the Applied work request facts and thinks about Mutt and Jeff, two AAWs who recently came to Kelley looking for work.

Fred securely logs onto the WorkCard system and sends a message indicating that he's interested in the work and that he's available to interview on a particular day noted as open for interviews by Applied. The Kelley manager does the same for Mutt and Jeff (who are not registered users of WorkCard themselves yet).

The system sends to Applied the available information regarding the two responses, in a format which was selected by Applied during the registration process. A manager at Applied who remembers Fred notifies the WorkCard system to assign Fred without an interview because he knows Fred to be a great AAW from past experience. Fred is electronically contacted (using his pager number in accord with his registration preferences) regarding the proposed assignment and particular facts again. He agrees with the assignment and makes this agreement known via an electronic transmission. Subsequently, he is assigned to one of the work requests. The WorkCard system automatically creates a timesheet and expense form accessible by Fred when he securely logs on, the timesheet incorporating the requirements of the work request and particular requirements of Applied indicated during the registration process or at some other time.

The Applied manager interviews Mutt and Jeff and decides only to hire Jeff on an AAW basis. The Applied manager securely logs onto the WorkCard system and indicates that he wants Jeff to be assigned to the other open work request. A message is sent to Kelley in regards to Jeff for the proposed assignment and particular facts. Jeff receives the message from Kelley and agrees with his employers at Kelley that he's amenable to working over at Applied for the two months. Kelley responds in agreement to the assignment and Jeff is provisionally assigned awaiting his registration as a WorkCard system user. After Jeff registers with WorkCard he receives his smartcard hardware token and is assigned to the other Applied open work request.

Electronic documents summarizing the terms of a new contractual relationship between Applied and the supplier (Kelley Temp Services and Fred for himself) for the particular work orders are sent by the WorkCard system to both parties for electronic confirmation. In this particular case, Kelley generally agrees to non-invoiced payment for them, but requires that a Kelley manager must approve timesheet information where a logic-backed interface fires a software flag indicating that the entered data is outside of bounds acceptable to Applied. Fred agrees that he's bound by the terms of the assignment documents which he approved and that he'll accept payment as soon as Applied approves it (non-invoiced payment).

The WorkCard system automatically creates a timesheet and expense form accessible by Fred when he securely logs on, the timesheet incorporating the requirements of the work request and particular requirements of Applied noted during the registration process or at some other time. By “automatically”, it is meant that the WorkCard system creates the worker's data input interface (using preferences chosen by the consumer during registration in the preferred variation; in another variation, the worker has the option to use his own preferred user interface, or that which is preferred by his supplier, as long as the data entered fulfills the requirements of the consumer) and updates the logic backing said interface as well as all of the resume, supplier, and consumer reporting flags which are important for the management reporting by each of these parties after the work-related information has been entered upon the interface by the particular worker.

Applied happens to have building security systems capable of reading the selected hardware tokens. During the registration, this fact was exploited and building security information is integrated into the work order and assignment process. When Fred and Jeff show up for the first day of the two-month project at Applied, the Applied building security system is already configured to allow them access only to the rooms and buildings deemed required by the work orders by Applied. The fact that Fred has already been through Applied's worker security clearance process in the last year appeared on his electronic resume which was viewed by the Applied manager before assignment of Fred. Jeff must go through the formal security clearance process before the WorkCard system will allow him to enter buildings or enter time or expense information onto the system. After he clears said process, this information will be entered upon his continually updated electronic resume on the WorkCard system.

Jeff and Fred begin to work in the Applied cleanroom. Every day, or at the end of each week, etc., they enter their timesheet and expense information onto the WorkCard system by securely logging onto the WorkCard system from an information system at Applied, from home using their personal computers having the proper hardware token interfacing equipment, from their internet and hardware token connected Palm Pilot, etc. and entering work-related data onto a secure central database using a local logic-backed interface.

During one very long week, they both end up working over 40 hours per week. This isn't noted until Friday when they their weekly total after data entry goes over 40 hours. The logic-backed WorkCard software with which they are interacting flags them, preferably by a small visual software flag which can be clicked-on for further explanation about how they are not, within the terms of the agreed-to assignment, supposed to work over 40 hours per week. As is statutorily required, the hours worked are entered—45 for each of the AAWs. At the end of the next pay period, the AAWs securely log on and are prompted to check over their timesheet and expense data, make edits if needed, electronically endorse the data, and click a button which results in sending the documents to their supervisor at Applied.

After they forward the endorsed documents to the Applied supervisor, he securely logs on and has the option to approve them or send them back for edits if he finds mistakes, etc. If he endorses them, he forwards them electronically to an Applied manager with authority to approve payment of the billing documents and cause non-invoiced payment of the suppliers. After the Applied manager with payment authority securely logs on and approves payment, Fred is electronically paid through the WorkCard system using electronic purse technology and his database file is updated to indicate that he was paid, and that Applied approved his work of the hours in a cleanroom. Before non-invoiced payment for Jeff's work, a Kelley manager must approve the relevant electronic documents and send a signal back to Applied via the WorkCard system due to the overtime flag. Although Fred is bound by his assent to the details of the assignment document he approved, he must be paid for the 5 hour overage as is required by state law. Jeff will also be paid for the overtime for the same reason, but Kelley will pay for the overage and not Applied, due to the contractual terms between the two parties established at the outset of the particular AAW resource transaction (although Kelley probably will attempt to charge Applied for the overtime since they received the benefit of the work).

1. A worker resource management system for placing invoicing generation under the control of a consumer comprising:
a. a central information system having a central database;
b. a local information system;
wherein a worker may logon to said central information system via said local information system, input work-related data to said central database, and forward said work-related data to said consumer for approval,
and wherein said consumer may logon to said central information system via said local information system, examine and approve said work-related data, and cause non-invoiced payment of a supplier based upon said work related data.

2. The system of claim 1 wherein said worker logon and said consumer logon are accomplished using secure logon procedure.

3. The system of claim 2 further comprising a hardware token, said hardware token configured to store authentication information.

4. The system of claim 3 wherein said authentication information is biometric information.

5. The system of claim 3 wherein said hardware token is configured to process a comparison between two sets of authentication information.

6. The system of claim 5 wherein said hardware token comprises a smart chip.

7. The system of claim 1 wherein said worker logon and said consumer logon are accomplished using semisecure logon procedures.

8. The system of claim 1 wherein said worker and said supplier are the same person.

9. The system of claim 1 wherein said local information system is portable.

10. The system of claim 1 wherein said central information system is an application service provider to said local information system.

11. The system of claim 1 wherein an electronic resume for said worker may be produced from updated information on said central database and observed using said local information system.

12. A method for managing worker resource information and placing invoice generation under the control of a consumer comprising:
a. providing a logicbacked interface through which said worker may logon to said central database, input work-related data to said central database, and forward said work-related data to said consumer for approval;
b. providing an interface through which said consumer may logon to said central database, examine and approve said work-related data, and cause non-invoiced payment of said supplier based upon said work-related data.

13. The method of claim 12 wherein said worker logon and said consumer logon are accomplished using secure logon procedures.

14. The method of claim 13 wherein said secure logon procedures involve a hardware token, said hardware token configured to store authentication information.

15. The method of claim 14 wherein said authentication information is biometric information.

16. The method of claim 14 wherein said hardware token is configured to process a comparison between two sets of authentication information.

17. The method of claim 16 wherein said hardware token comprises a smart chip.

18. The method of claim 12 wherein said worker logon and said consumer logon are accomplished using semisecure logon procedures.

19. The method of claim 12 wherein said worker and said supplier are the same person.

20. The method of claim 12 wherein said logic-backed interface may be accessed from a portable information device.

21. The method of claim 12 wherein said central database is accessed via a local information device for which said central database is an application service provider.

22. A worker resource data management apparatus comprising:
a. means for allowing restricted worker access to a central database, wherein said worker is able to enter work-related data through a logic-backed interface and forward said work-related data to a consumer for approval;
b. means for allowing restricted consumer access to a central database, wherein said consumer is able to examine and approve said work-related data and cause non-invoiced payment to a supplier based upon said work-related data.
